(19) United States
(12) Patent Application Publication
(10) Pub. No.: US 2010/0007980 A1
(43) Pub. Date: Jan. 14, 2010

(54) HEAT-ASSISTED MAGNETIC RECORDING HEAD GIMBAL ASSEMBLY

(75) Inventors: Hyun-jei Kim, Yongin-si (KR); Sung-dong Suh, Yongin-si (KR); Kook-hyun Sunwoo, Yongin-si (KR); Eun-hyoung Cho, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/301,179

(22) PCT Filed: May 15, 2007
(86) PCT No.: PCT/KR07/02369

§ 371 Date: Dec. 3, 2008

(30) Foreign Application Priority Data
May 17, 2006 (KR) 10-2006-0044400

(51) Int. Cl. G11B 5/02

(52) U.S. Cl. 360/59; G9B/21.023

(57) ABSTRACT

Provided is a heat-assisted magnetic recording (HAMR) head gimbal assembly including a light source module including a light source emitting light, an HAMR head including a magnetic recording head including a recording pole for applying a magnetic recording field to a magnetic recording medium and a return pole magnetically connected with the recording pole to form a path of the magnetic field, and an optical transmission module which is formed on one side of the magnetic recording head and guides light incident from the light source module, a head slider including having a trailing edge whereon the HAMR head is formed, and a suspension attached to an end of an actuator arm, wherein the head slider is formed on an end of the suspension, and a sink part in which the light source module is installed and which is formed separated from the head slider, wherein the sink part is formed on a surface on which the head slider of the suspension is formed, and the light source module is formed on a surface on which the suspension of the light source module is formed.

### CROSS-REFERENCE TO RELATED PATENT APPLICATION

This application is a National Stage of International Application No. PCT/KR2007/002369 filed May 15, 2007 and claims the benefit of Korean Patent Application No. 10-2006-0044400, field on May 17, 2006, in the Korean Intellectual Property Office, the disclosure of which is incorporated herein in its entirety by reference.

### FIELD OF THE INVENTION

The present invention relates to a heat-assisted magnetic recording head gimbal assembly, and more particularly, to a heat-assisted magnetic recording head gimbal assembly in which light transferring loss can be reduced in order to improve heat transfer.

### DESCRIPTION OF THE RELATED ART

It has become known that it is impossible to achieve a recording density above 500 Gb/in using a conventional magnetic recording method. In the field of magnetic information recording, many studies have been performed to overcome magnetic recording density limitations and thus achieve high recording density.

In order to increase the recording density, a bit size of magnetic recording mediums on which unit information is recorded must be reduced. To reduce the bit size, a grain size of the recording medium must be reduced. Since reduction of the grain size increases the thermal instability of a recorded bit, a medium having a relatively high coercive force is necessary.

Since a magnetic field generated by a magnetic recording head and applied to a magnetic recording medium has a limited intensity, it is impossible to record information in a magnetic recording medium when the magnetic recording medium is formed of a material having a relatively high coercive force for providing good thermal stability.

To solve the above problem, a heat-assisted magnetic recording method has been developed, in which a recording medium formed of a material having a relatively high coercive force for overcoming the thermal instability of a small recorded bit is used and heat is locally applied to the recording medium to temporarily lower the coercive force thereof and allow the recording to be performed by a magnetic field applied by a magnetic recording head. That is, according to the heat-assisted magnetic recording method, the coercive force of a local portion of the recording medium is lowered by heating the local portion so that the heated local portion of the magnetic recording medium can be effectively magnetized to perform the recording using the magnetic field applied by the magnetic recording head. Therefore, even when the grain size of the magnetic recording medium is reduced, the thermal stability can be realized.

An optical element that heats a local portion of a magnetic recording medium by emitting light to temporarily reduce the coercive force of the local portion of the recording medium and thus expedite the recording may be applied to a heat-assisted magnetic recording (HAMR) head.

FIG. 1 is a partly cross-sectional view of a slider 35 of a heat-assisted magnetic recording head gimbal assembly disclosed in U.S. Pat. No. 6,404,706. Referring to FIG. 1, a laser module 22 including a laser diode 24 and a submount 26 is affixed right on the slider 35. A read/write head 50 is formed at a trailing edge of the slider 35. In FIG. 1, reference number 40 indicates a flexure, and reference number 41 indicates a stainless steel frame supporting the slider 35. The stainless steel frame 41 is included in the flexure 40.

The read/write head 50 includes a write head section 60 and a read head section 61. The read head section 61 includes a magneto-resistive (MR) read head 62 formed between a first shield 80 and a second shield 85. The write head section 60 includes a first pole 85, which may function as the second shield 85 of the read head section 61, a second pole 96 separated from the first pole 85 by a write gap 98, and a coil 94.

An optical waveguide 88 is formed in the write gap 98. A laser beam emitted from the laser diode 24 is guided through the optical waveguide 88 to irradiate a magnetic recording medium (not shown).

In the conventional head gimbal assembly of FIG. 1, since the laser module 22 is affixed right on the slider 35, heat generated from the laser diode 24 cannot be effectively radiated.

In addition, when a hard disk drive (HDD) having the HAMR head gimbal assembly is driven, a power of a laser diode should be controlled according to a driving condition. For this, a photodetector is affixed to a laser module so that it may be positioned behind the laser diode in order to be used for Automatic Power Control (APC). However, in the conventional head gimbal assembly of FIG. 1, since the laser diode 24 is affixed right on the slider 35, it is difficult to employ a photodetector for APC.

To increase a power of a laser diode, a length of a cavity of the laser diode should be lengthened. With regard to the conventional head gimbal assembly of FIG. 1, since the thickness of the laser module 22 affixed on the slider 35 is large, when two head gimbal assemblies are stacked to be form two channels, the laser modules 22 are in contact with each other. Thus, it is impossible to use the head gimbal assembly of FIG. 1.

Meanwhile, considering the radiation of the heat generated from the laser diode, the use of the photodetector for APC, and the stacking of two head gimbal assemblies, the laser module should be formed so as to be separated from the slider of a suspension instead of affixing it right on the slider. Thus, an optical transmission between the laser module and the HAMR head may be provided through an optical waveguide such as an optical fiber, and the like. Also, a technical solution minimizes an optical loss.

### SUMMARY OF THE INVENTION

The present invention provides a heat-assisted magnetic recording head gimbal assembly in which a light source module is formed so as to be separated from a slider of a suspension to minimize light loss between the laser source module and the heat-assisted magnetic recording (HAMR) head.

The present invention also provides an improved heat-assisted magnetic recording head gimbal assembly in which heat emitted from the laser diode can be radiated effectively, wherein a photodetector may be used for Automatic Power Control (APC), and two laser modules are not in contact with each other even when they are stacked to form at least two channels.

According to an aspect of the present invention, there is provided a heat-assisted magnetic recording head gimbal assembly including: a light source module including a light source emitting light; a heat-assisted magnetic recording (HAMR) head including a magnetic recording head including a recording pole for applying a magnetic recording field to a magnetic recording medium and a return pole magnetically connected with the recording pole to form a path of the magnetic recording field, and an optical transmission module which is formed on one side of the magnetic recording head and guides the light incident from the light source module; a head slider including the HAMR head formed on a trailing edge of the head slider; and a suspension attached to an end of an actuator arm, wherein the head slider is formed on an end of the suspension, and a sink part in which the light source module is installed and which is formed at a position separated from the head slider, wherein the sink part is formed on the surface on which the head slider of the suspension is formed, and thus the light source module is formed on the surface on which the suspension of the light source module is formed.

The suspension may include an attaching section to be attached to the end of the actuator arm; a load beam section including the head slider formed on an end of the load beam section; and a mid section formed on the load beam section and the attaching section, wherein the sink part is formed on any one of the load beam section and the mid section, and thereby the light source module is formed on any one of the load beam section and the mid section.

The suspension may include: an attaching section attached to the end of the actuator arm; a load beam section including the head slider formed on an end of the head slider; a mid section formed between the load beam section and the connecting section; and a wing formed on an outer part of any one of the connecting section, the load beam section, and the mid section, wherein the sink part is formed on the wing part, and the light source module is installed in the sink part formed on the wing.

The optical transmission module may include: a first optical waveguide formed on one side of the magnetic recording head and guiding light incident from the light source; and a nano aperture altering an intensity distribution of the guided light through the first optical waveguide to facilitate a light field.

The first optical waveguide may include an inclined surface inclined with respect to a light axis of the incident light, and the nano aperture is arranged on a path of light reflected on the inclined surface.

The head gimbal assembly may further include a reading sensor.

The head gimbal assembly may further include a second optical waveguide guiding the light emitted from the light source module to the optical transmission module, wherein the second optical waveguide is arranged on the surface of the suspension on which the head slider is formed.

The light source module may include a sub-mount and a laser diode installed in the sub-mount, wherein one of the sink part and the sub-mount is formed so that a step difference between an emitting position of the laser diode and the second optical waveguide formed on the suspension is reduced.

The light source module may further include a photodetector attached to one side of the laser diode installed in the sub-mount, wherein the light source module provides APC.

The sub-mount may be formed of a silicon material, the light source module further includes photodetectors stacked monolithically on one side of the laser diode installed in the sub-mount, and the light source module is driven using Automatic Power Control (APC).

The light source module may further include a semiconductor substrate and a laser diode formed on the semiconductor substrate, wherein one of the sink part and the semiconductor substrate is formed so that a step difference between the emitting position of the laser diode and the second optical waveguide formed on the suspension is reduced.

The semiconductor substrate may be formed of a silicon material, the light source module further includes photodetectors stacked monolithically on one side of the laser diode formed on the semiconductor substrate, and the light source module provides APC.

### BRIEF DESCRIPTION OF THE DRAWINGS

The above and other features and advantages of the present invention will become more apparent by describing in detail exemplary embodiments thereof with reference to the attached drawings in which:

FIG. 1 is a partly cross-sectional view of a slider of an HAMR head gimbal assembly disclosed in U.S. Pat. No. 6,404,706;

FIG. 2 is a schematic plane view illustrating an HAMR head gimbal assembly according to an embodiment of the present invention;

FIG. 3 is a schematic conceptual view illustrating the head gimbal assembly of FIG. 2;

FIG. 4 illustrates schematically an arrangement of a light source module and head slider of FIG. 2;

FIGS. 5 A through 5C illustrates light source modules included in an HAMR head gimbal assembly according to various embodiments of the present invention;

FIG. 6 illustrates various positions in which a sink part included in the HAMR head gimbal assembly according to an embodiment of the present invention may be formed;

FIG. 7 is a view illustrating an HAMR head gimbal assembly according to another embodiment of the present invention.

FIG. 8 is a schematic perspective view illustrating an HAMR head formed on a trailing edge of a head slider, according to an embodiment of the present invention;

FIG. 9 is a partial perspective view illustrating an optical transmission module of FIG. 8; and

FIG. 10 is a schematic perspective view illustrating a hard disk drive using the HAMR head gimbal assembly according to the present invention.

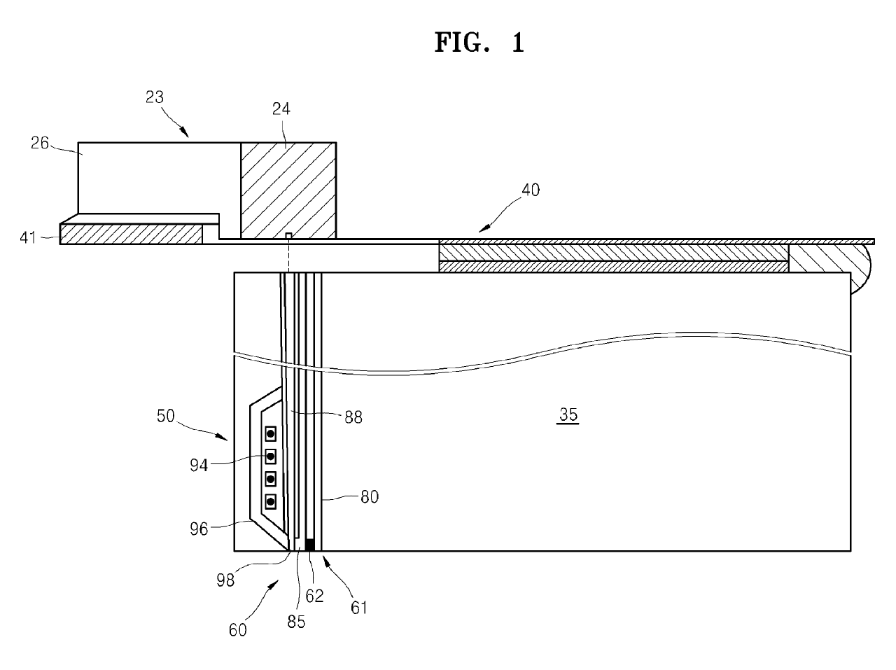

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

To effectively radiate heat generated from a laser diode constituting a heat source, a light source module is arranged to be separated from a head slider. Here, in order to minimize light loss between the light source module and an HAMR head mounted on the head slider, an optical waveguide, for example, an optical fiber, which guides the heat from the light source module to the HAMR head, may be affixed onto a surface to which a suspension of the head slider is affixed. For this, the light source module may be affixed onto a surface to which the head slider is attached. However, since the thickness of the light source module may be thicker than that of the head slider, the light source module may be in contact with a surface of a magnetic recording medium. The present invention solves these problems since the light source is attached into a sink part of the suspension. In the HAMR head gimbal assembly according to the present invention, the heat generated from the light source module can be radiated effectively by attaching the light source module to be separated from the head slider, and a photodetector is attached to the light source module for Automatic Power Control (APC).

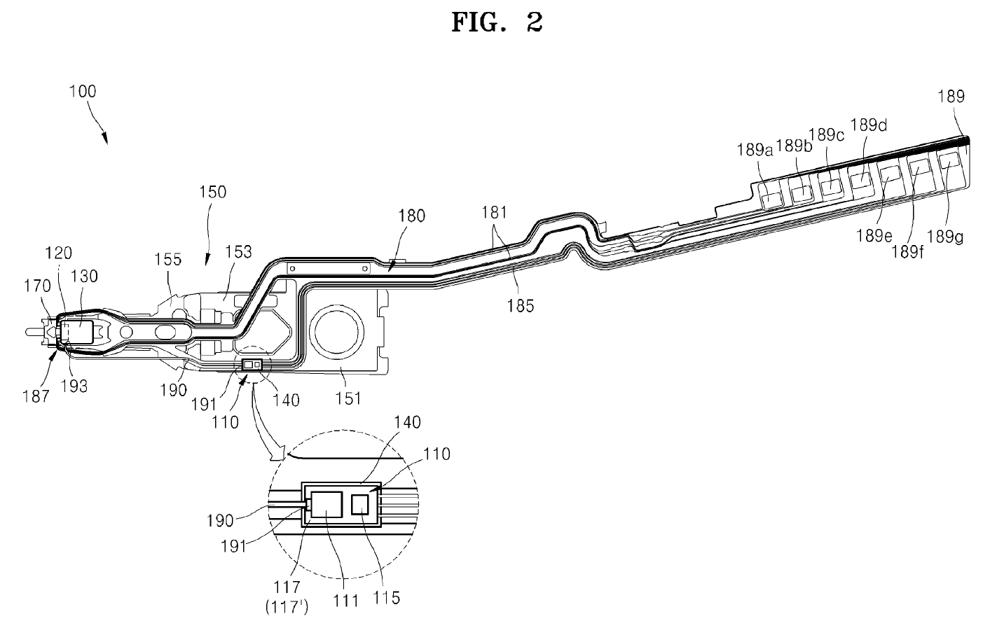

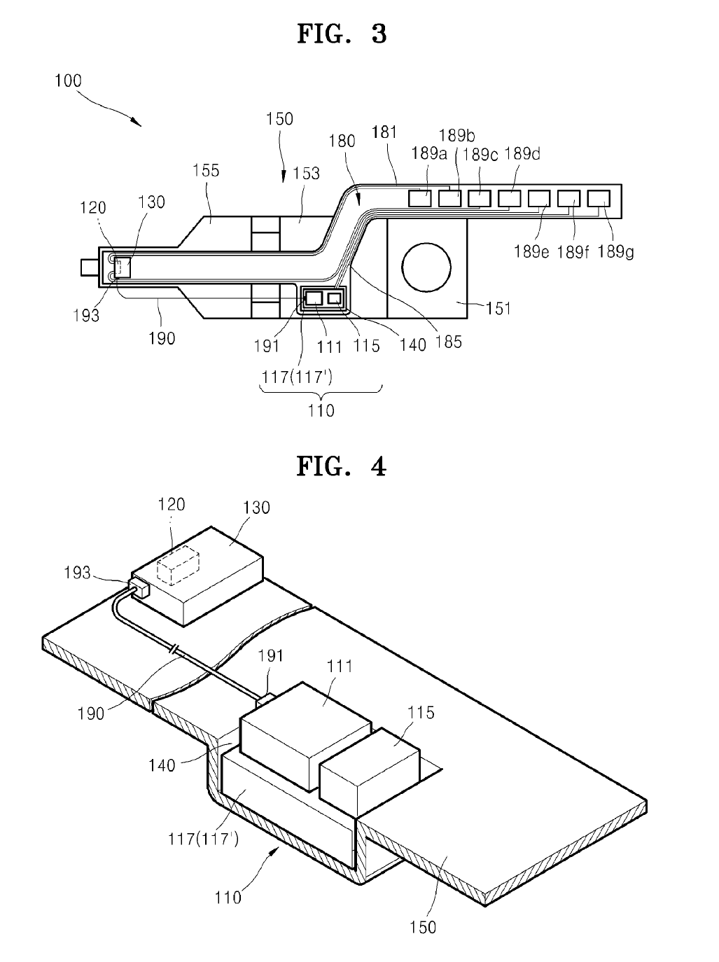

FIG. 2 is a schematic plane view illustrating an HAMR head gimbal assembly 100 according to an embodiment of the present invention, FIG. 3 is a schematic conceptual view illustrating the head gimbal assembly 100 of FIG. 2, and FIG. 4 illustrates schematically an arrangement of a light source module 110 and head slider 130 of FIG. 2.

Referring to FIGS. 2 through 4, the HAMR head gimbal assembly 100 includes the light source module 110, the head slider 130, and a suspension 150. An HAMR head 120 is formed at a trailing edge of the head slider 130. The head slider 130 is formed at the end of the suspension 150. The suspension 150 includes a sink part 140 where the head slider 130 is attached.

The light source module 110 includes a laser diode 111 as a light source emitting light. The laser diode 111 may be installed in a sub-mount 117 or formed integrally on a semiconductor substrate 117′. The light source module 110 further includes a photodetector 115. The photodetector 115 is used for APC and placed next to one side of the laser diode 111.

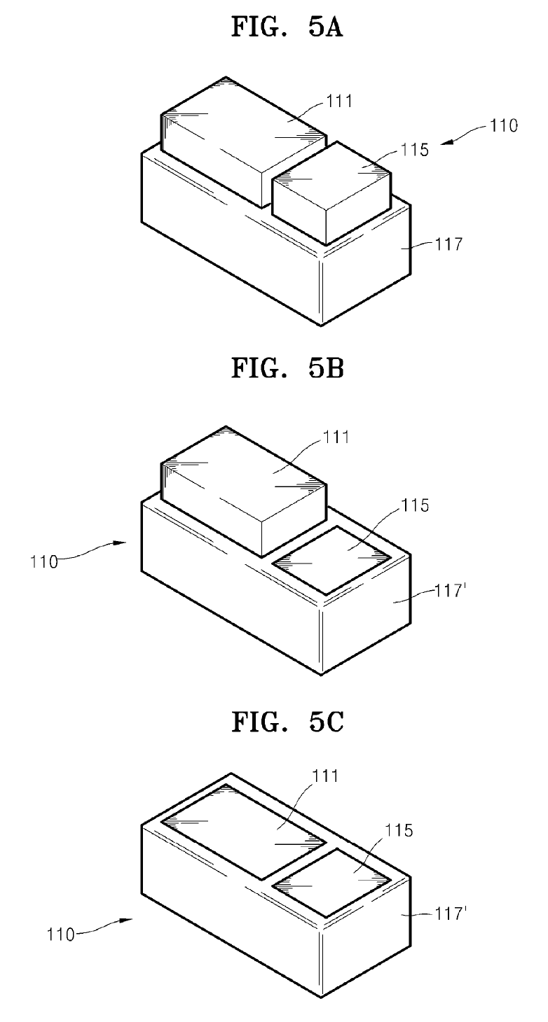

FIGS. 5 A through 5C illustrates the light source module 110 according to various embodiments of the present invention. Referring to FIG. 5 A, the light source module 110 includes the sub-mount 117, and the laser diode 111 installed in the sub-mount 117. The light source module 110 further includes the photodetector 115 placed next to one side of the laser diode 111 and used for APC.

The sub-mount 117 may be formed of silicon or other materials, for example, a metal such as Au, Ag, AIN, SiC, Al, TiN, or the like having a good thermal conductivity in the range of 50 through 500 W/mK.

The laser diode 111 and/or photodetector 115 may be wire-bonded or flip-chip bonded to the sub-mount 117.

Referring to FIG. 5B, the light source module 110 includes the semiconductor substrate 117′ formed of a semiconductor material, for example, a silicon material, the laser diode 111 mounted on the semiconductor substrate 117′, and the photodetector 115 mounted on the semiconductor substrate 117′ and located on one side of the laser diode 111. The photodetector 115 may be stacked on the semiconductor substrate 117′ monolithically. The laser diode 111 of the light source module 110 may be wire-bonded or flip-chip bonded to the semiconductor substrate 117′.

Referring to 5C, the light source module 110 includes the semiconductor substrate 117′, and the laser diode 111 formed on the semiconductor substrate 117′. The light source module 110 further includes the photodetector 115 attached on one side of the laser diode 111 mounted on the semiconductor substrate 117′. The photodetector 115 may be stacked on the semiconductor substrate 117′ monolithically. The semiconductor substrate 117′ is formed of, for example, a silicon material.

Referring to FIGS. 2 through 4, the suspension 150 includes an attaching section 151 attached to an end of an actuator arm, a load beam section 155 installing the head slider 130, and a mid section 153 formed between the load beam section 155 and the attaching section 151. A flexure 170 is installed at an end of the load beam section 155, and the flexure 170 supports the head slider 130. That is, the head slider 130 is connected with the load beam section 155 by the medium of the flexure 170. A flexible cable 180 is connected with the suspension 150. Here, the flexible cable 180 includes a plurality of electrical lead lines 181 electrically connected with the HAMR head 120 on the flexure 170, and a plurality of electrical lead lines 185 electrically connected with the light source module 110.

A connecting section 187 of the electrical lead lines 181 for the HAMR head 120 is supported by the flexure 170 to be electrically connected with the head slider 130. Some of the electrical lead lines 185 are electrically connected with the light source module 110. Electrical contact pads 189a through 189g for an electrical connection between the electrical lead lines 181 and 185 and other respective circuits (not shown) are formed on a region 189 of the flexible cable 180 separated from the load beam section 155. Referring to FIGS. 2 and 3, the two contact pads 189a and 189b for reading signals, the two contact pads 189c and 189d for writing signals, the one contact pad 189e for applying driving current to the laser diode 111, the one contact pad 189f for transporting a signal detected from the photodetector 115 for providing APC, the contact pad 189g for a ground, etc. are formed to be connected to the flexible cable 180. Referring to FIG. 3, a region 189, on which the electrical contact pads 189a through 189g of the flexible cable 180 are formed, is formed on one side of the attaching section 151, but it will be understood by those of ordinary skill in the art that various changes may be made without departing from the spirit and scope of the invention.

The suspension 150 includes the sink part 140 into which the light source module 110 is installed. As illustrated in FIGS. 2 through 4, the sink part 140 is formed on the surface on which the head slider 130 of the suspension 150 formed.

Referring to FIGS. 2 and 3, the sink part 140 is formed on some part of the mid section 153. The sink part 140 may be formed on some part of the load beam section 155.

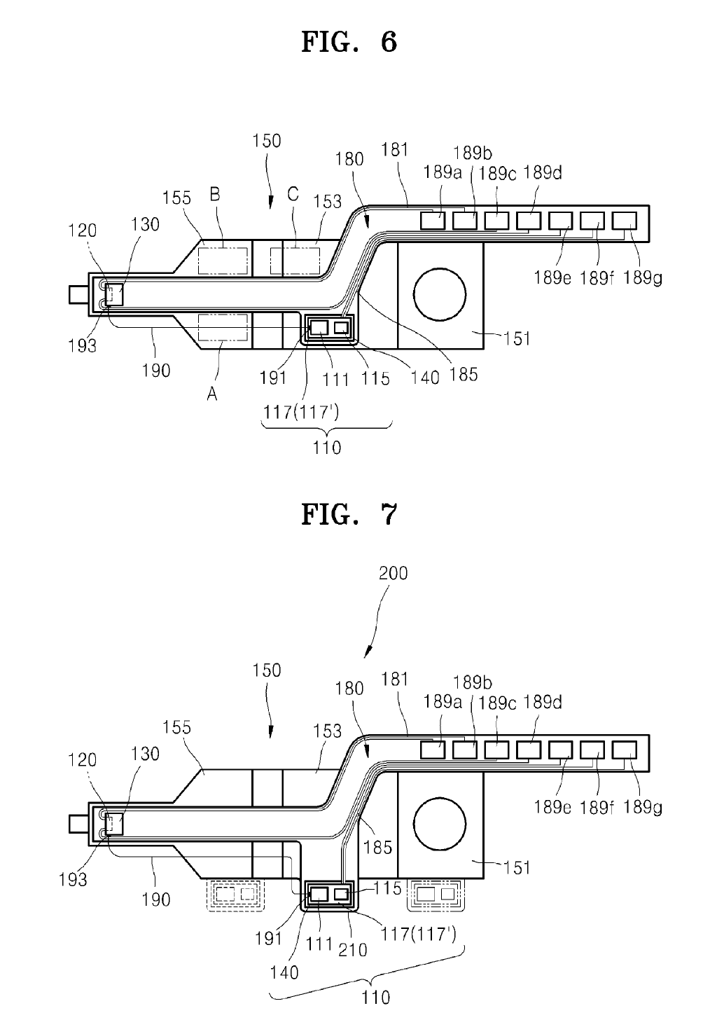

FIG. 6 illustrates various positions in which the sink part 140 included in the HAMR head gimbal assembly 100 according to an embodiment of the present invention may be formed. Referring to FIG. 6, boxes A, B and C indicate various positions in which the sink part 140 and the light source module 110 installed thereto may be formed. The sink part 140 may be formed on any one of the load beam section 155 and mid section 153, and thereby the light source module 110 can be formed on any one of the load beam section 155 and the mid section 153.

FIG. 7 is a view illustrating an HAMR head gimbal assembly 200 according to another embodiment of the present invention. FIG. 7 illustrates various positions in which the sink part 140 and the light source module 110 may be formed.

Referring to FIG. 7, in the HAMR head gimbal assembly 200, the suspension 150 further includes a wing 210 formed on an outer part of any one of the attaching section 151, the load beam section 155 and the mid section 153. The sink part 140 is formed on the wing 210. The light source module 110 is installed on the sink part 140 formed on the wing 210.

As illustrated in FIG. 7 by a full line, the wing 210 and the sink part 140 may be formed on the outer part of the mid section 153. Also, as illustrated by dotted lines, the wing 210 and the sink part 140 may be formed on the load beam section 155 or the outer part of the attaching section 151. In the structure having the wing 210 on which the sink part 140 formed as illustrated in FIG. 7, the light source module 110 may be formed on an outer part of the attaching section 151. Here, the heat from the light source 111 is radiated easily to further increase thermal stabilization.

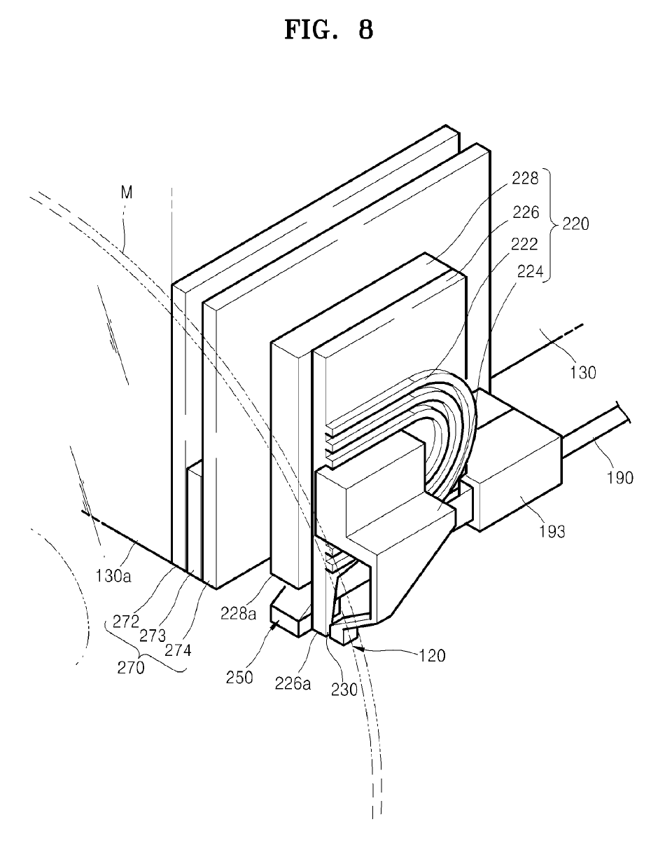

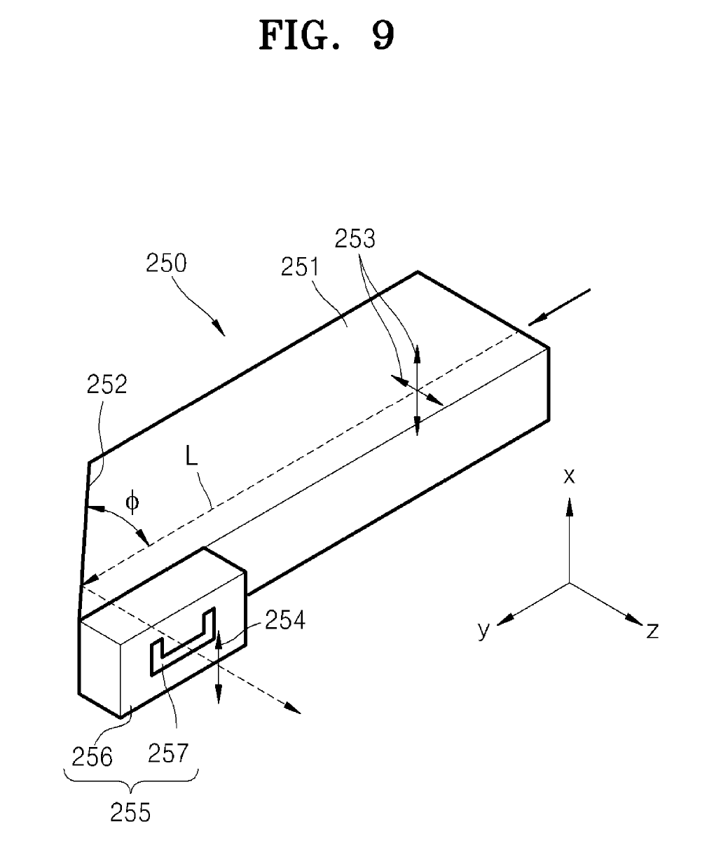

FIG. 8 is a schematic perspective view illustrating the HAMR head 120 formed on the trailing edge of the head slider 130, and FIG. 9 is a partial perspective view illustrating an optical transmission module 250 of FIG. 8.

Referring to FIGS. 8 and 9, one end of the HAMR head 120 is installed on the trailing edge of the head slider 130 including an air bearing surface (ABS) 130a so that it may be fitted to the ABS 130a. As a magnetic recording medium M having a recording surface facing with the ABS 130a rotates with high speed, the HAMR head 120 floats together with the head slider 130 by an air bearing system at a predetermined distance from the magnetic recording medium M.

The HAMR head 120 includes a magnetic recording head 220, and the optical transmission module 250 which is arranged on one end of the magnetic recording head 220 and irradiates the light transmitted from the light source module 110 to a local region of the magnetic recording medium M. In addition, the HAMR head 120 further includes a reading sensor 270.

The magnetic recording head 220 generates a magnetic field for data recording. The magnetic recording head 220 includes a coil 222 generating the magnetic field, a return yoke 224 constituting a path of the magnetic field generated around the coil 222, a recording pole 226, which is separated from one end of the return yoke 224 and is connected with other end of the return yoke 224 and constitutes a path of the magnetic field together with the return yoke 224, and a sub-yoke 228 connected with one surface of the recording pole 226 to form the path of the magnetic field.

One surface of the return yoke 224 and the recording pole 226 facing the magnetic recording medium M are arranged on the ABS 130a.

A gap 230 having a predetermined distance is formed between one end of the return yoke 224 and the recording pole 226. The magnetic flux around the recording pole 226 leaks to an outer part of the recording pole 226 and magnetizes the magnetic recording medium M during the data recording.

The sub-yoke 228 is formed on the side of the recording pole 226. The sub yoke 228 includes a first end 226a and a second end 228a facing the magnetic recording medium M. The second end 228a and the first end 226a are formed to have a stepped structure. The sub-yoke 228 concentrates effectively the magnetic field for data recording onto the first end 226a of the recording pole 226 to enlarge the leakage flux around the gap 230. Since the concentration of the magnetic field is limited by a saturation magnetization value of materials of elements forming the path of the magnetic field, the saturation magnetization value of materials for forming the recording pole 226 may be greater than that of the sub-yoke 228.

At least part of the optical transmission module 250 is arranged in a space which is formed between the first end 226a and the second end 228a.

A reading sensor 270 includes a first shield 272, a second shield 274 and a reading sensor part 273 arranged between the first shield 272 and the second shield 274. One surface of the first shield 272, the second shield 274, and the reading sensor part 273 facing magnetic recording medium M are arranged on the ABS 130a.

The optical transmission module 250 guides the light emitted from the light source module 110 to irradiate to the magnetic recording medium M to heat it locally. Thereby, a coercive force of the magnetic recording medium M is temporally reduced to facilitate data recording.

FIG. 9 illustrates the optical transmission module 250 according to an embodiment of the present invention. Referring to FIG. 9, the optical transmission module 250 includes an optical waveguide 251 guiding the light from the light source module 110, and a nano aperture 255 generating a strengthened near field by altering an intensity (energy) distribution of the guided light.

An inclined surface 252 is formed with respect to a light axis L of incident light on one end of the optical waveguide 251, and alters a light path to a direction toward the nano aperture 255. Here, the inclined surface 252 makes a predetermined angle [phi] with respect to the light axis L. Here, [phi] has an optimized value so that the light energy form the optical transmission module 250 may be maximized, and is defined by Equation (1).

φ=90°−θ_{iL} Equation (1)

where θ_{iL} is the Brewster's angle defining a direction in which perpendicularly polarized light (in a direction of X axis) of the incident light is reflected, θ_{iL} is calculated using Equation (2).

θ_{iL}=tan⁻¹(n₂/n₁) Equation (2)

where n₂ is a refraction index of the optical waveguide 251, and n₂ is a refraction index of an outer part of the optical waveguide 251 at the boundary with the inclined surface 252. That is, when polarized light 253 is incident onto the inclined surface 252 at an incident angle of θ_{iL} with respect to a boundary surface between a medium having the refraction index n₁ and a medium having the refraction index n₂, only perpendicularly polarized light 254 is reflected.

The nano aperture 255 is formed along the path of the light reflected on the inclined surface 252. The nano aperture 255 allows a light field of the particularly polarized light to be strengthened effectively. The nano aperture 255 includes a slit 257 having a predetermined shape formed in a metal film 256. When the perpendicularly polarized light shown in FIG. 9 is guided toward the nano aperture 255, the slit 257 is formed to have a perpendicular narrow width. In the center of the slit 257 having the narrow width, an electric field is strengthened by a vibration of an electric dipole to concentrate the light energy of a wide region on a local region. The slit 257 has a ‘C’ shape as illustrated in FIG. 9, or alternatively, has a bow tie shape, an ‘X’ shape, an ‘L’ shape, etc.

When the light 253 is incident onto the optical waveguide 251, only the perpendicularly polarized light 254 is reflected by the inclined surface 252 to be guided into the nano aperture 255. The light energy concentrated on the local region by the nano aperture 255 is radiated to heat a predetermined region of the magnetic recording medium. The region having a small coercive force due to heating is magnetized by the leakage flux of the recording pole 226 to perform data recording.

The HAMR head 120 described with reference to FIGS. 8 and 9 may be used in the HAMR gimbal assemblies 100 and 200, but examples of the HAMR head are not limited thereto. Other HAMR heads having various structures may be used in the HAMR head gimbal assemblies 100 and 200.

In the HAMR head gimbal assemblies 100 and 200, light is transmitted between the light source module 110 and the optical transmission module 250 of the HAMR head 120 through an optical waveguide, for example, an optical fiber 190.

Optical couplers 191 and 193 may be formed between the laser diode 111 and one end of the optical fiber 190, and between other end of the optical fiber 190 and the optical waveguide 251.

The optical fiber 190 is arranged on a surface to which the head slider 130 is affixed. A depth of the sink part 140 may be optimized so that a step difference between an emitting position of the laser diode 111 affixed in the sink part 140 and the optical fiber 190 formed on the suspension 150 may be reduced according to a thickness of the sub-mount 117 or the semiconductor substrate 117′.

When the optical fiber 190 is attached to a surface to which the head slider 130 is adhered for the HAMR head 120, light loss can be minimized because the length of the optical fiber 190 is shortened, and thus numbers of refraction and light coupling are reduced.

To further minimize the light loss, the light source module 110 is attached to very surface to which the head slider 130 is adhered. However, when the thickness of the light source module 110 is thicker than that of the head slider 130, since the light source module 110 may be in contact with the magnetic recording medium, for example, during driving a hard disk drive, the suspension 150 should be lowered to load the light source module 110.

Since in the head gimbal assemblies 100 and 200, the light source module 110 is placed on the surface of the sink suspension 150, the head gimbal assemblies 100 and 200 meet the above requirement.

That is, in the HAMR head gimbal assemblies 100 and 200, the light source module 110 having the thickness thicker than that of the head slider 130 is installed in the sink part 140 formed on the surface on which the head slider 130 is adhered. That is, the light source module 110 is attached directly to the suspension 150. Thus, the light loss between the light source module 110 and the optical transmission module 250 can be minimized in the HAMR head gimbal assembly 100 or 200. The light source module 110 may not be in contact with the magnetic recording medium surface. In addition, when two HAMR head gimbal assemblies 100 or 200 are stacked to form at least two channels, the light source modules 110 are not in contact with each other.

Since a step difference between an emitting position, which is defined by a p-cladding layer of the sub-mount 117 or the semiconductor substrate 117′ and the laser diode 111, and the optical fiber 190 formed on the suspension 150 may be reduced, an optical alignment can realized easily.

By attaching the light source module 110 to a position separated from the head slider 130, the heat from the light source module 110, in particular, from the laser diode 111, can be radiated effectively. The light source module 110 includes the photodetector 115 for APC.

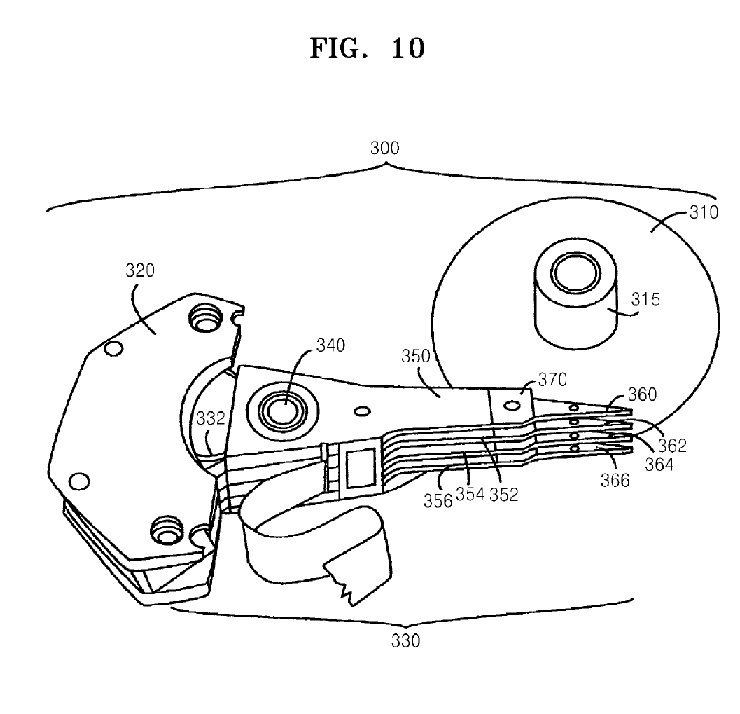

FIG. 10 is a schematic perspective view illustrating a hard disk drive having the HAMR head gimbal assembly according to the present invention.

Referring to FIG. 10, a hard disk drive 300 includes an actuator assembly 330. The actuator assembly 330 includes at least one of actuator arms 350, 352, 354 and 356, which are connected with at least one of head gimbal assemblies 360, 362, 364 and 366 and to which a voice coil 332 is attached. Meanwhile, the head gimbal assemblies 360, 362, 364 and 366 may each be the HAMR head gimbal assembly 100 or 200.

The voice coil 332 is firmly attached to the actuator arms 350, 352, 354 and 356. The actuator arms 350, 352, 354 and 356 are wound around an actuator axis 340 by the voice coil 332 interacting with a permanent magnet 320. Thereby, the HAMR head 120 is arranged so that it may trace a track on a surface of a rotating disk 310.

The head gimbal assemblies 360, 362, 364 and 366 are each attached to the actuator arms 350, 352, 354 and 356 by an attaching section 370.

Accordingly, the hard disk drive 300 can record data with higher recording density than a conventional perpendicular magnetic recording type hard disk drive.

Since the light source module 110 is installed in the sink part 140 of the suspension 150, the heat-assisted magnetic recording head gimbal assemblies 360, 362, 364 and 366 can be stacked to form a plurality of channels, for example, four channels as illustrated in FIG. 10.

The HAMR head gimbal assembly according to the present invention includes a sink part formed on a predetermined region of a suspension separated from a head slider so that a light source module may be formed on the surface on which the head slider is formed. In addition, the light source module is installed in the sink part. Thus, light loss between the light source module and an optical transmission module in the HAMR head gimbal assembly can be minimized. The light source module may not be in contact with a magnetic recording medium surface.

The heat generated from the light source module, in particular, from the laser diode, can be radiated effectively. A photodetector for APC can be used in the heat-assisted magnetic recording head gimbal assembly.

When two HAMR head gimbal assemblies are stacked to form at least two channels, the laser modules may not be in contact with each other. Thus, magnetic recording devices having a plurality of channels can be realized.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A heat-assisted magnetic recording (HAMR) head gimbal assembly comprising:
a light source module comprising a light source emitting light;
an HAMR head comprising a magnetic recording head comprising a recording pole for applying a magnetic recording field to a magnetic recording medium and a return pole magnetically connected with the recording pole to form a path of the magnetic field, and an optical transmission module which is formed on one side of the magnetic recording head and guides light incident from the light source module;
a head slider having a trailing edge whereon the HAMR head is formed; and
a suspension attached to an end of an actuator arm, wherein the head slider is formed on an end of the suspension, and a sink part in which the light source module is installed and which is formed a separated from the head slider, wherein the sink part is formed on a surface on which the head slider of the suspension is formed, and the light source module is formed on a surface on which the suspension of the light source module is formed.

2. The HAMR head gimbal assembly of claim 1, wherein the suspension comprises:
an attaching section to be attached to the end of the actuator arm;
a load beam section having an end whereon the head slider is formed; and
a mid section formed on the load beam section and the attaching section, wherein the sink part is formed on any one of the load beam section and the mid section, and the light source module is formed on any one of the load beam section and the mid section.

3. The HAMR head gimbal assembly of claim 1, wherein the suspension comprises:
an attaching section attached to the end of the actuator arm;
a load beam section having an end whereon the head slider is formed;
a mid section formed between the load beam section and the connecting section; and
a wing formed on outer part of any one of the connecting section, the load beam section, and the mid section, wherein the sink part is formed on the wing part, and the light source module is installed in the sink part formed on the wing.

4. The HAMR head gimbal assembly of claim 1, wherein the optical transmission module comprises:
a first optical waveguide formed on one side of the magnetic recording head and guiding light incident from the light source; and
a nano aperture altering an intensity distribution of the guided light through the first optical waveguide to facilitate a light field.

5. The HAMR head gimbal assembly of claim 4, wherein the first optical waveguide has an inclined surface inclined with respect to a light axis of the incident light, and the nano aperture is arranged in a path of light reflected from the inclined surface.

6. The HAMR head gimbal assembly of claim 1, further comprising a reading sensor.

7. The HAMR head gimbal assembly of claim 1, further comprising a second optical waveguide guiding the light emitted from the light source module to the optical transmission module, wherein the second optical waveguide is arranged on a surface of the suspension on which the head slider is formed.

8. The HAMR head gimbal assembly of claim 7, wherein the light source module comprises:
a sub-mount; and
a laser diode installed in the sub-mount, wherein one of the sink part and the sub-mount is formed so that a step difference between an emitting position of the laser diode and the second optical waveguide formed on the suspension is reduced.

9. The HAMR head gimbal assembly of claim 8, wherein the light source module further comprises a photodetector attached to one side of the laser diode installed in the sub-mount, wherein the light source module is used for Automatic Power Control (APC).

10. The HAMR head gimbal assembly of claim 8, wherein the sub-mount is formed of a silicon material, the light source module further comprises photodetectors stacked monolithically on one side of the laser diode installed in the sub-mount, and the light source module is driven using APC.

11. The HAMR head gimbal assembly of claim 7, wherein the light source module further comprises:
a semiconductor substrate; and
a laser diode formed on the semiconductor substrate, wherein one of the sink part and the semiconductor substrate is formed so that a step difference between the emitting position of the laser diode and the second optical waveguide formed on the suspension is reduced.

12. The HAMR head gimbal assembly of claim 11, wherein the semiconductor substrate is formed of a silicon material, the light source module further comprises photodetectors stacked monolithically on one side of the laser diode formed on the semiconductor substrate, and the light source module is used for APC.
